(19) United States
(12) Patent Application Publication
(10) Pub. No.: US 2014/0036203 A1
(43) Pub. Date: Feb. 6, 2014

(54) LIGHT MIXTURE FOR A DISPLAY UTILIZING QUANTUM DOTS

(71) Applicant: APPLE INC., Cupertino, CA (US)

(72) Inventors: Jean-Pierre S. GUILLOU, San Francisco, CA (US); Shawn R. GETTEMY, San Jose, CA (US); David A. DOYLE, San Francisco, CA (US)

(73) Assignee: Apple Inc., Cupertino, CA (US)

(21) Appl. No.: 13/665,271

(22) Filed: Oct. 31, 2012

Related U.S. Application Data
(60) Provisional application No. 61/677,951, filed on Jul. 31, 2012.

(51) Int. Cl. G02F 1/13357; G02F 1/13

(52) U.S. Cl. 349/62; 349/187

(57) ABSTRACT

Utilization of quantum dots in displays and the location of the quantum dot sheet within the stackup of the backlight can lead to issues such as non-uniform light mixing, non-uniform brightness, and off-axis changes in color. The mismatch between the isotropic nature of light emitted from the quantum dots and the light emitted directly from the light source can be alleviated by utilization of diffusers and prism sheets. The diffusers and prism sheets can be further utilized to change the angle of light such that it is directed upwards towards the top of the display for improved uniformity in brightness and enhanced performance. Placement of the diffuser sheets, prism sheets, and changes in the design of the components, such as the light guide path, can alleviate the issues by properly mixing the colors together in order to achieve a uniform distribution of colors in the display.

### FIELD OF THE DISCLOSURE

This relates generally to mixing of light for a display utilizing quantum dots, and more particularly, to achieving uniform color and brightness.

### BACKGROUND OF THE DISCLOSURE

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

LCD devices typically include multiple picture elements (pixels) arranged in a matrix. The pixels may be driven by scanning line and data line circuitry to display an image on the display that can be periodically refreshed over multiple image frames such that a continuous image may be perceived by a user. Individual pixels of an LCD device can permit a variable amount light from a backlight to pass through the pixel based on the strength of an electric field applied to the liquid crystal material of the pixel. The electric field can be generated by a difference in potential of two electrodes, a common electrode and a pixel electrode. In some LCDs, such as electrically-controlled birefringence (ECB) LCDs, the liquid crystal can be in between the two electrodes. In other LCDs, such as in-plane switching (IPS) and fringe-field switching (FFS) LCDs, the two electrodes can be positioned on the same side of the liquid crystal.

The backlight often contains light emitting diodes (LEDs), such as blue or UV LEDs, that are coated with a phosphor such as Yttrium Aluminum Garnet (YAG) in order to produce a white light, which the liquid crystal layer then uses to render desired colors for the display. One metric that can be used to judge the quality of a display is the color gamut produced by the backlight. Color gamut refers to the color space that can be displayed, and the ability to precisely define the colors can then allow for a larger color gamut by either using individual colors or a combination of several colors. The properties of YAG phosphor can lead to colors with broad spectral width, resulting in displays that have dull and muted colors. One way to improve the color gamut is to replace the YAG phosphor layer with quantum dots (QDs), which can achieve colors with narrow spectral widths that are wavelength tunable. The QDs can achieve pure colors with a wider color gamut leading to displays that can be more crisp and vibrant. However, one of the problems with replacing the YAG phosphor layer with a QD sheet is that light that has not excited a quantum dot may not be isotropic, and the three different colors (red, green, and blue) may not be uniformly mixed. Diffuser(s), prism sheets and changes in the design of the components such as the light guide path can alleviate this issue by properly mixing the colors together in order to achieve a uniform distribution of colors in the display.

### SUMMARY OF THE DISCLOSURE

Configurations in the order of a sub-stackup of layers in a backlight of a display can change the light mixing in displays utilizing quantum dots. In some examples, a quantum dot sheet can be located between a reflector and a light guide path. The light guide path can be tuned to direct light downwards such that the quantum dots can be excited first. In some examples, the quantum dot sheet can be located between the light guide path and a diffuser sheet. The quantum dot sheet can be tuned to account for the angle and intensity of incoming light. In some examples, the quantum dot sheet can be placed between the diffuser sheet and a bottom prism sheet. In some examples, the quantum dot sheet can be placed between the prism sheets and the liquid crystal module. Due to the light being tightly collimated after it passes through the prism sheet, a diffuser between the quantum dot and liquid crystal module may be needed for proper light mixing. In some examples, the quantum dot sheet can be embedded in the light guide path. This can lead to a thinner profile for the display due to the fewer number of overall layers in the sub-stackup. In some examples, any of the diffuser sheets can be replaced with a gradient diffuser sheet or a high density diffuser sheet. Additionally, in some examples, the prism sheets can be replaced with diffuser sheets.

### BRIEF DESCRIPTION OF THE DRAWINGS

FIG. 1A illustrates an example mobile telephone that includes an LCD display screen according to some disclosed examples.

FIG. 1B illustrates an example digital media player that includes an LCD display screen according to some disclosed examples.

FIG. 1C illustrates an example personal computer that includes an LCD display screen according to some disclosed examples.

FIG. 2 illustrates the quantization of energy levels in quantum dots and corresponding sizes.

FIG. 3 illustrates the sharp color peaks that can be achieved by utilizing quantum dots.

FIG. 4 illustrates an exemplary stackup of layers in the backlight of a display utilizing a YAG phosphor layer.

FIG. 5 illustrates an exemplary stackup of layers in the backlight of a display utilizing quantum dots where the QD sheet is located between the reflector and light guide path.

FIG. 6 illustrates an exemplary stackup of layers in the backlight of a display utilizing QDs where the QD sheet is located between the light guide path and a diffuser sheet.

FIG. 7 illustrates an exemplary stackup of layers in the backlight of a display utilizing QDs where the QD sheet is located between a diffuser sheet and the bottom prism sheet.

FIG. 8 illustrates an exemplary stackup of layers in the backlight of a display utilizing QDs where the QD sheet is located between the top prism sheet and a second diffuser sheet.

FIG. 9 illustrates an exemplary stackup of layers in the backlight of a display utilizing QDs where the QD sheet is embedded in the light guide path.

FIG. 10 is a block diagram of an example computing system that illustrates one implementation of an example touch screen according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to the mixture of light paths of a display system using QDs. Utilization of QDs and its location within the sub-stackup of the backlight can lead to issues such as non-uniform light mixing, non-uniform brightness, and off-axis changes in color. Further, due to location of the edge emitting LEDs and the light guide path, a loss of light intensity can occur along the length of the light guide path as the distance away from the LEDs is increased. The mismatch between the isotropic nature of light emitted from the QDs and the light emitted directly from the backlight LEDs can be alleviated by utilization of diffusers and prism sheets. The diffusers and prism sheets can be further utilized to change the angle of light such that it is directed upwards towards the top of the display for improved uniformity in brightness and enhanced performance. By utilizing gradient diffusers or high density diffusers, the issue with non-uniform brightness and off-axis changes in color can be resolved.

In some examples, the QD sheet can be located between the reflector and light guide path. The light guide path can be tuned to direct light downwards first, such that the QDs can be excited. Further, light can be directed out of the light guide path using patterns along the light guide path called extraction features. Examples of extraction features can include, but are not limited to grooves or dots on the top or bottom of the light guide. In some examples, the QD sheet can be located between the light guide path and the first diffuser sheet. The QD sheet can be tuned to account for the angle and intensity of incoming light. In some examples, the QD sheet can be placed between the first diffuser sheet and the bottom prism sheet. In some examples, the QD sheet can be placed on top of the bottom and top prism sheets. Due to the light being tightly collimated after it passes through the prism sheet, a diffuser above the prism sheets may be needed for proper light mixing. In some examples, the QD sheet can be embedded in the light guide path. This can lead to thinner profile for the display due to the fewer number of overall layers in the sub-stackup. In some examples, an additional diffuser sheet can be placed between the top prism sheet and the liquid crystal module for further light mixing, to compensate for any non-uniformities, or to account for hotspots.

One potential problem can be loss of light intensity along the length of the light guide path, as the distance from the edge emitting LEDs is increased. To compensate for this, in some examples, any of the diffuser sheets can be a gradient diffuser sheet. One further problem can be that the collimated, on-axis light from the light that does not excite QDs can have higher intensity than off-axis light. This can lead to non-uniform brightness and non-uniform color mixing. To solve this problem, a high density diffuser sheet can be used to allow for dispersion of the collimated, on-axis light with matched intensity to the off-axis light. In some examples, a high density diffuser sheet can be inserted below the QD sheet to ensure uniform intensity of light impinging on the QD sheet. Additionally, these properties can be achieved by replacing the prism sheets with diffuser sheets.

Although examples disclosed herein may be described and illustrated in terms of displays that utilize edge emitting LEDs, it should be understood that the examples are not so limited, but are additionally applicable to top emitting LEDs, bottom emitting LEDs, side emitting LEDs, or any type of light source. Furthermore, although examples may be described in terms of displays, it should be understood that the examples are not so limited, but are additionally applicable to displays that are integrated with touch screens which can accept touch inputs from a user or object such as a stylus. Additionally, although examples may be described in terms of quantum dot (QD) sheet, it should be understood that the examples are not so limited, but are additionally applicable to glass tube or an enclosure full of quantum dots.

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

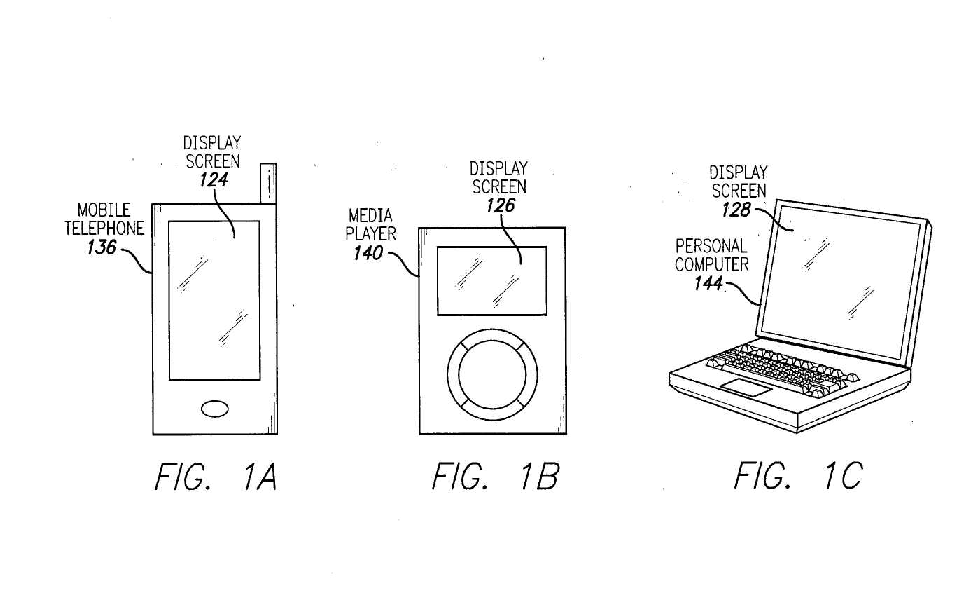

FIGS. 1A-1C show example systems in which LCD screens (which can be part of touch screens) according to examples of the disclosure may be implemented. FIG. 1A illustrates an example mobile telephone 136 that includes an LCD display screen 124. FIG. 1B illustrates an example digital media player 140 that includes an LCD display screen 126. FIG. 1C illustrates an example personal computer 144 that includes an LCD display screen 128. Although not shown in FIGS. 1A-1C, tablet computers can also include display screens according to examples of the disclosure. LCD display screens 124, 126 and 128 can include numerous layers that are stacked on top of each other and bonded or otherwise attached together to form the display.

Displays used in devices such as mobile devices, telephones, computers, and electronics often utilize LED-backlit liquid crystal displays (LCDs). These LED-backlit LCDs are often comprised mainly of a backlight unit and a liquid crystal module (LCM). The LCM can contain millions of sub-pixels for the red, green, and blue colors. White LEDs can be used as a source for the backlight, which has a color spectrum comprised of complimentary blue and yellow colors, which appear to be white. The white LED can be supply light to a yttrium-aluminum garnet (YAG) phosphor layer, outputting a spectrum rich of blue wavelengths with a weak green and a weak red component. In order to let the light pass through as much as possible, a spectrally broad color filter can then be used. The YAG phosphor cannot be precisely tuned to match the wavelength of the color filter, so a spectrally broad color filter can be used to help maximize the efficiency. However, this can lead to poor color quality and a poor color gamut. Green colors will not be true green, but instead will have tints of yellow, and red colors will have tints of orange.

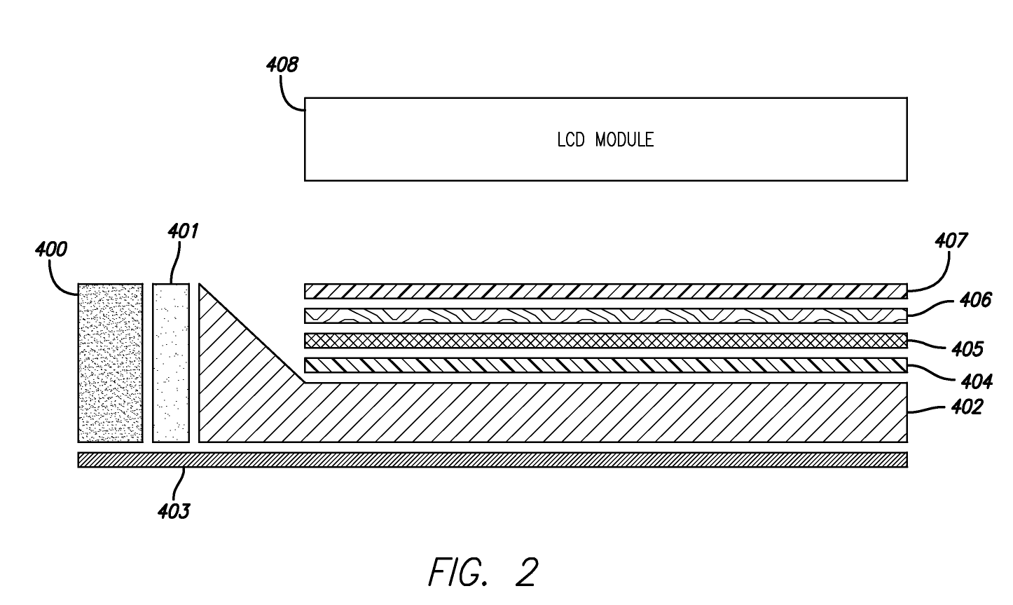

FIG. 2 illustrates the stackup of layers in an exemplary backlight utilizing LEDs for an LCD display. The backlight stackup can include elements 400-407, to be explained in greater detail below. Edge emitting LEDs 400 can be used as the light source to produce white light. Light emitted from the LEDs can pass through a YAG phosphor layer 401 that can be configured to output red, blue, and green wavelengths of light into a light guide 402. The backlight sub-stackup can include a plurality of layers such as the light guide 402, reflector 403, diffuser sheets 404 and 407, and prism sheets 405 and 406. The light coming from the LEDs can enter the sub-stackup and travel through the light guide, which spatially distributes the light uniformly across the display. The light guide can be tuned such that light entering the light guide can be turned upwards towards the liquid crystal module 408 or downwards towards the reflector 403. This can be done using a series of shapes such as grooves or dots on the top or bottom of the light guide called extraction features. The light exiting the light guide can be controlled by adjusting the size and density of the shapes. Light directed towards the bottom can be reflected back into the light guide with the reflector. Light directed upwards can then be mixed with better angular uniformity once it passes through the bottom diffuser 404. Following, a bottom prism sheet 405 and a top prism sheet 406 can be placed on top of the bottom diffuser to direct light more towards the top. Finally, further mixing can be done using a top diffuser 407, and the light can then enter into the liquid crystal module.

To overcome some of the disadvantages of these LED-backlit LCDs, quantum dots can be used. Quantum dots (QDs) are tiny, nanocrystal phosphors that can be about 2-10 nm in size. They can be distinguishable from a YAG phosphor due to their energy levels and resultant broad spectral emissions. Emission from both the YAG phosphor and QDs can occur when they become excited with sufficient energy to jump to the next energy level. The electron will then want to return to its lowest energy state or the ground state, and in doing so, will release energy in the form of electromagnetic radiation. The electron will fall back down to the ground state, emitting a photon with a wavelength corresponding to the difference between the lowest energy state and the ground state. For YAG phosphors, emission from its lowest excited level to the ground state can lead to an extremely broad emission band with a large full-width half maximum (FWHM). This is different for quantum dots, where their small size leads to quantum confinement resulting in energy levels that are discrete and quantized with finite separation. When the quantum dots are excited, the same thing can happen wherein the electromagnetic radiation corresponding to the wavelength can be released in the form of light. These discrete energy levels for the QDs can allow for precise tunability of the emitted photon and spectral emission with narrow FWHM less than 40 nm. By changing the size of the QD, the wavelength of the output emission can be shifted and nearly any frequency of light in the Visible spectrum can be achieved, leading to precise colors and a much wider color gamut than achieved with a YAG phosphor.

To utilize QDs in a display, they can be pumped with any source with a shorter wavelength or higher energy, such as a UV source (<400 nm) used to excite blue (450 nm<λ<500 nm), green (500 nm<λ<570 nm), and red (610 nm<λ<760 nm) QDs. Additionally, due to the inherently narrow spectral width of a blue LED, a Blue source can be used to excite green and red QDs. To achieve Red emission, larger QDs (For example, 6 nm in size) may be fabricated. Green emission can require medium-sized QDs (For example, 4 nm in size), and Blue emission can require very small-sized QDs (For example, 2 nm in size). For example, an array of 4 nm and 6 nm sized QDs can be used with a blue GaN LED light source to form all three colors for the LCM. By combining the different emission spectra from the QD output with the blue LED output, a spectrum of white light can be achieved. At that stage, the white light can look the same as the output from the YAG phosphor; however, the white light from the QD sheet can now be tri-chromatic. Unlike the display utilizing the YAG phosphor, the display utilizing QD sheet can have light from the QDs that can be tuned to match the wavelength of the color filters. Once the QD light output is sent through the color filter, the distinction between the colors can then become very pure with lower loss of light and higher efficiency.

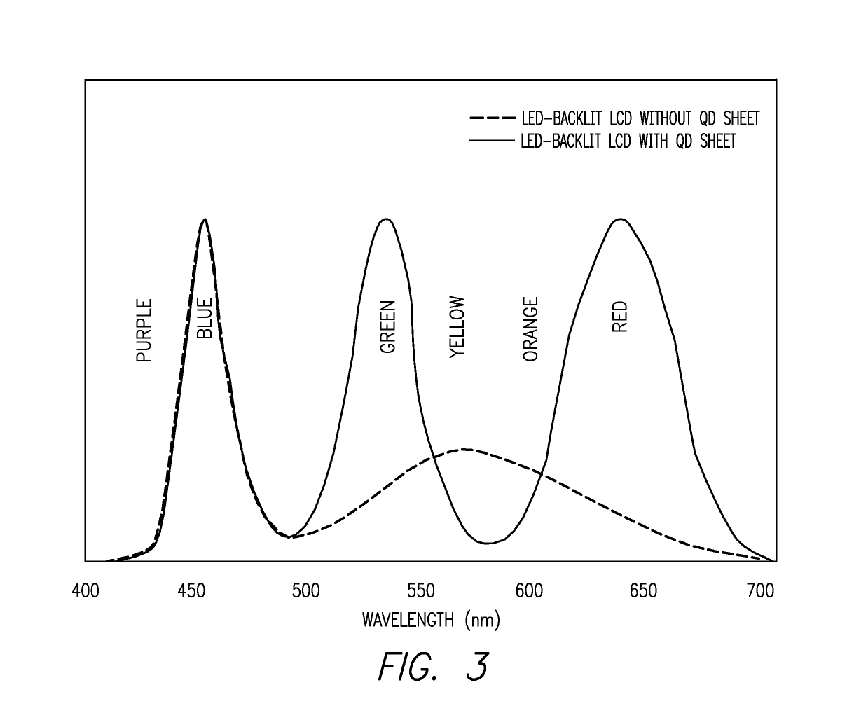

Utilizing QDs to achieve a high color gamut or broader spectrum of color can be achieved by simply inserting the QD sheet and replacing the YAG phosphor in the LED-backlit LCDs. Isolation of one particular color or wavelength and achieving very saturated colors can be customized. More vibrant, brilliant colors can be displayed by being able to achieve very sharp, saturated reds from large-sized QDs, very sharp, saturated greens from medium-sized QDs, and sharp, saturated blue from small-sized QDs, or they can be inherently achieved from the blue GaN LED. A simple tweak in the QD size and the combination of the three colors can allow for any hue from this larger color gamut to be displayed. The sharp color peaks of an example display utilizing a QD sheet compared to an example display not utilizing a QD sheet is shown in FIG. 3.

In addition to the pure colors and larger color gamut, the QDs can offer a more uniform display of colors and brightness due to the isotropic nature of the light exiting the QDs. This is unlike the LED backlit LCDs without QDs, where the light coming from the light path can be collimated. The collimated light can lead to non-uniform display or further problems such as hotspots. Further, replacing the YAG phosphor with a QD sheet can come at a minimal increase in cost and manufacturing ease while enhancing display performance for more vibrant, brilliant, and pure colors. The red, green, and blue QDs can use the same materials and their dot size can be the only difference for achieving the two different colors, whereas it can be harder to fabricate the YAG phosphor due to the need for multiple materials for the different colors. Since the YAG phosphor layer can be a separate entity and not integrated into the LCM or backlight, a simple replacement can be made, with the QD sheet and the white LEDs replaced with any light source, such as blue LEDs or a UV light source.

Referring back to FIG. 2, to utilize QDs in exemplary LED-backlit LCDs, the YAG phosphor layer 401 can be replaced with a QD sheet and the appropriate LED light source can be used. However, the thermal properties of the edge emitting LEDs can lead to performance degradation and reliability issues with the QD sheet. A solution to this problem can be to place the QD sheet further away from the LEDs and into the sub-stackup of diffuser and prism sheets. This solution may not incur any significant changes in procedure or cost in the manufacturing process. However, a problem with this approach can be that the large number of reflections in the light guide path can no longer be effective for light mixing. Examples of the disclosure tackle this problem by using a series of diffuser and prism sheets to mix the light for uniform color distribution at all viewing angles. The placement of the QD sheet in the sub-stackup can influence the placement of the diffuser and prism sheets, properties of the diffuser and prism sheets, properties of the QD sheet, and properties of the light guide path in order to achieve the best light mixing.

The configuration described above can present difficulties. By placing the QD sheet next to the light source, the QD sheet may be susceptible to deformities or degradation from sources such as heat generated from the light source. For instance, quantum dots in a QD sheet need to maintain a particular separation from adjacent quantum dots and need to properly adhere to the sheet. This separation between adjacent dots and adherence to the sheet can be maintained by a chemical that agglutinates each dot. This can prevent dots from colliding or adhering to one another. Heat from the light source can be one source that can cause the agglutination to degrade and the quantum dots to move in position. Any shift in position of the quantum dots can cause the pattern of light emitted from the QD sheet to lose proper functionality and can cause shifts in color and defects in the images displayed.

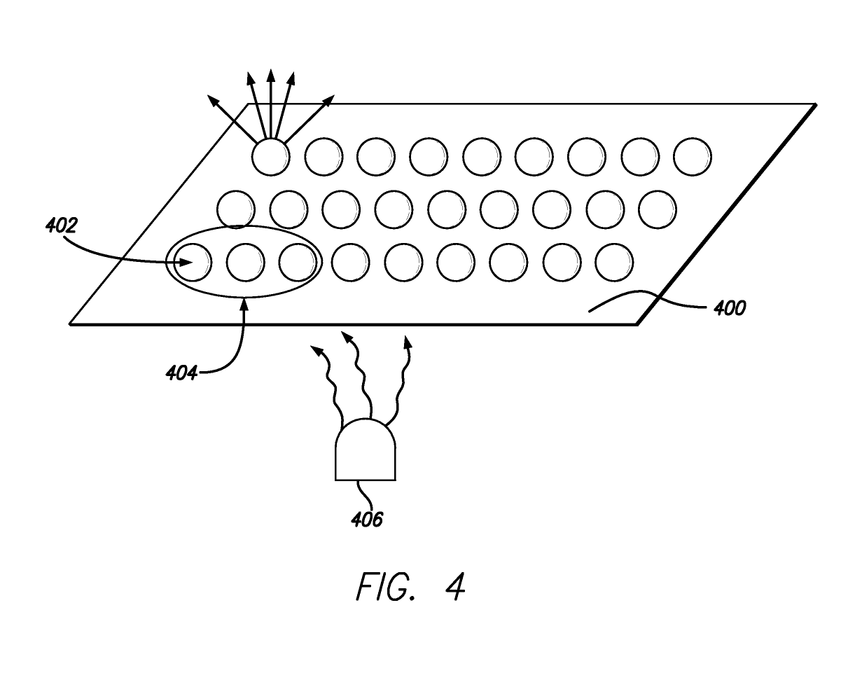

FIG. 4 illustrates an exemplary QD sheet according to disclosed examples. QD sheet 400 can contain individual quantum dots 402. The quantum dots can be arranged in groups 404, such that each group contains, for example, three quantum dots: one red, one green, and one blue. The light can be generated by each group when mixed together to produce white light. In other examples, a blue LED can be used to excite red and green quantum dots, obviating the need for a quantum dot that emits blue light. Thus, the red and green light emitted from the quantum dots can be mixed with the light from the blue LED that can pass through the QD sheet to form white light. QD sheet can be excited by a light source 406. Light can be emitted from example sources, such as LEDs or UV light. Light source can provide the energy required to excite the quantum dots, so that they emit photons of light at precisely tuned wavelengths. The wavelengths can be tuned by adjusting the size of the quantum dots. When the light source excites a quantum dot, each quantum dot can release light that is isotropic. In other words, the light emitted from a quantum dot will be emitted uniformly in all directions from the quantum dot. This feature of quantum dots can play a significant role in determining where in the display architecture the QD sheet can be integrated. In some examples, the QD sheet can have varying thickness to control the distribution of colors. In some examples, the QD sheet can have varying density and/or spatial separation of quantum dots to enhance light mixing and display performance.

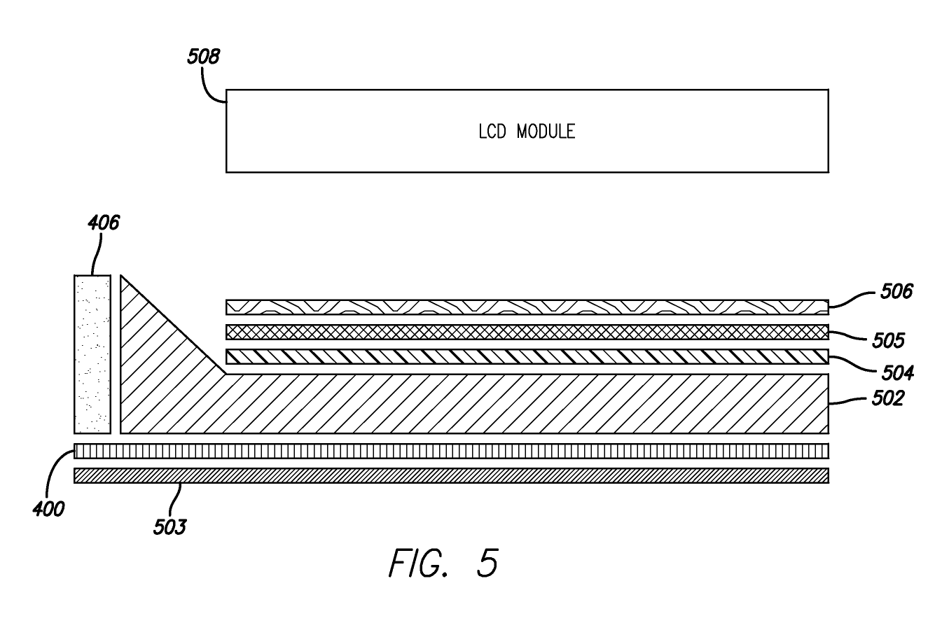

FIG. 5 illustrates an exemplary stackup of layers in a display system utilizing QDs with a QD sheet 400 located between the reflector 503 and light guide path 502. The light source can be directed into the light guide path 502. The light guide path can then spatially distribute and direct the light out of the light guide path along the length of the path. To ensure some of the light excites the QDs, the light guide path can be tuned to direct light downwards first, towards the QD sheet. Furthermore, the extraction features in the light guide path can be tuned to allow certain light to pass through the top. The light directed downward that passes through the QD sheet or excites QDs directed downwards can then be reflected upwards by the reflector, and the reflector can block light from exiting the display from the bottom. Light directed downwards can hit the QD sheet and excite the QDs, transforming the light into the appropriate color depending on excitation energy. The spatial separation and/or density of the QD sheet can be optimized to enhance the light mixing and display performance. Therefore, some of the light exiting the light path can be directly from the edge emitting LEDS and some of the light can be emitted from excited QDs. Because the light out coming from excited QDs can be inherently isotropic and the light from the edge emitting LEDs may not be, a diffuser sheet 504 can then be used to make the light directly from the edge emitting LEDs also isotropic to match the light emitted from the QDs. Next, a bottom prism sheet 505 and a top prism sheet 506 can be placed on top of the diffuser sheet. These prism sheets can be used to direct the light to an appropriate angle for best display performance and enhanced brightness. Finally, the isotropic light from all three colors can enter the liquid crystal module 508. In some examples, an additional diffuser sheet can be placed between the top prism sheet and the liquid crystal module for further light mixing, to compensate for any non-uniformities, or to account for hotspots. In some examples, any of the diffuser sheets can be a gradient diffuser sheet that can be used to compensate for loss of light intensity along the length of the light guide path. In some examples, a high density diffuser sheet can be inserted between the QD sheet and light guide path to ensure uniform intensity of light at all viewing angles. In some examples, the bottom prism sheet and top prism sheet can be replaced by diffuser sheets.

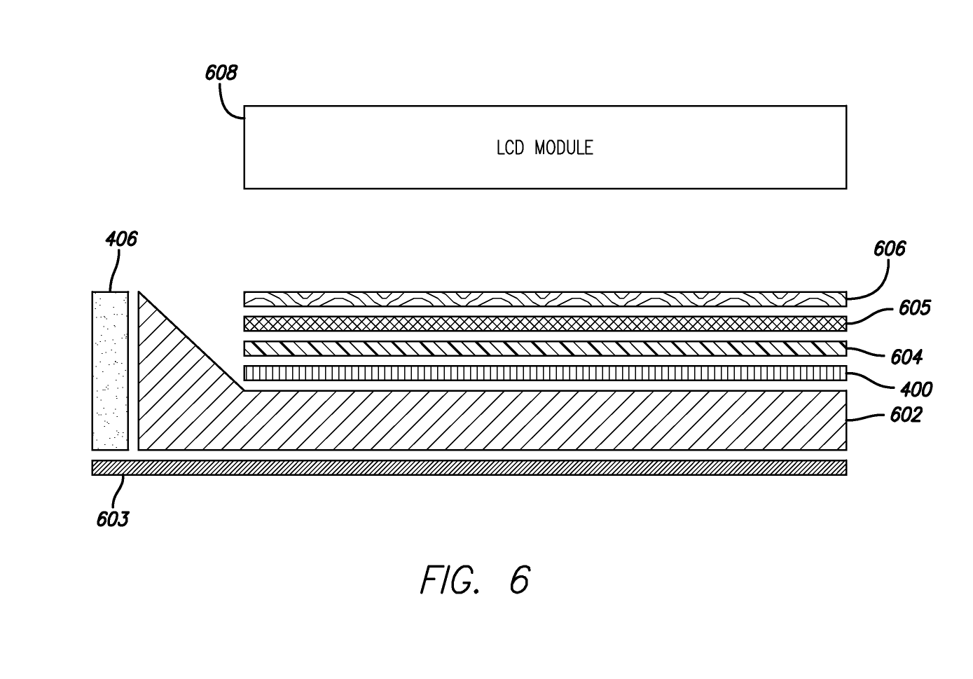

FIG. 6 illustrates an exemplary stackup of layers in a display system utilizing QDs with QD sheet 400 located between the light guide path 602 and diffuser sheet 604. Edge emitting LEDS can provide the light source 406, directed into the light guide path 602. The light guide path can then spatially distribute and direct the light out of the light guide path along the length of the path. The light guide path can be optimized to direct light upwards. Any light that is directed downwards can be reflected and directed upwards by the reflector 603. Some of the light coming out of the light guide path can hit the QD sheet and excite the QDs, transforming the light into the appropriate color depending on excitation energy. The QD sheet can be tuned for a certain angle and intensity of incoming light and its spatial uniformity can be optimized. The distribution of QDs or the thickness of the QD sheet can be controlled such that the distribution of colors seen at the top of the display can be equal. The light that does not excite the QDs can pass through the QD sheet and can be collimated and off axis, so the light may need to be made isotropic to match the characteristics of the light from the QDs. The purpose of the diffuser sheet 604 can be to make the light that has passed through the QD sheet isotropic and to further mix this light with the light emitted from the QDs. The light can then pass through a bottom prism sheet 604 and top prism sheet 605 to direct the angle of light upwards more towards the liquid crystal module 608 and the top of the display. In some examples, an additional diffuser sheet can be placed between the top prism sheet and the liquid crystal module for further light mixing, to compensate for any non-uniformities, or to account for hotspots. In some examples, any of the diffuser sheets can be a gradient diffuser sheet that can be used to compensate for loss of light intensity along the length of the light guide path. In some examples, a high density diffuser sheet can be inserted between the light guide path and the QD sheet to ensure uniform intensity of light impinging on the QD sheet. In some examples, the bottom prism sheet and top prism sheet can be replaced by diffuser sheets.

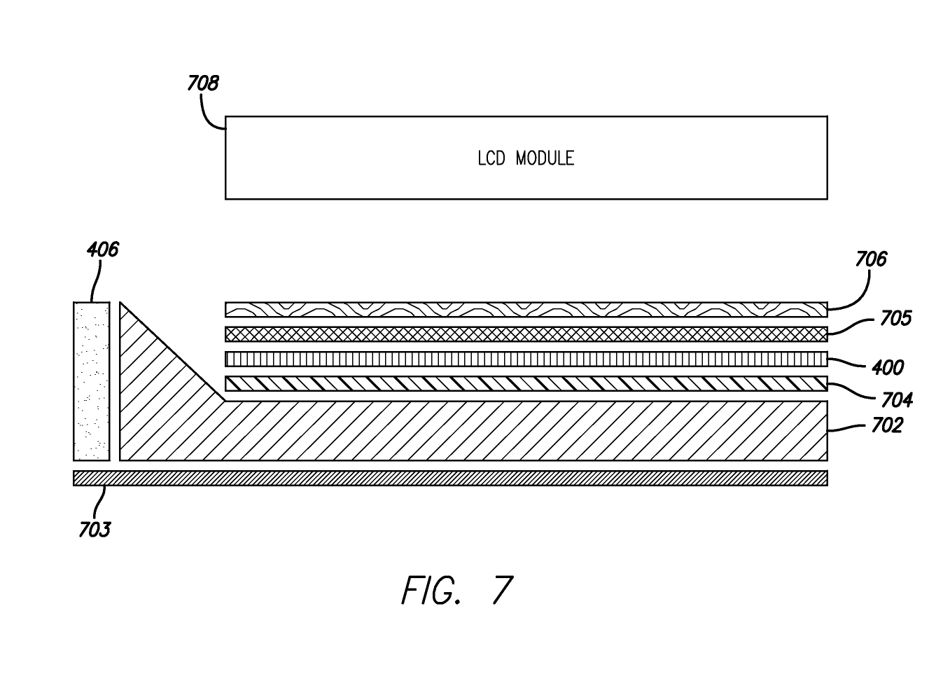

FIG. 7 illustrates an exemplary stackup of layers in a display system utilizing QDs with QD sheet 400 located between the diffuser sheet 704 and bottom sheet 705. Bottom sheet 705 can be a bottom prism sheet, for example. Edge emitting LEDs can provide the light source 406, directed into the light guide path 702. The reflector 703 can reflect and block light from exiting the display from the bottom. The light guide path can then spatially distribute and direct the light out of the light guide path along the length of the path. The light guide path can be optimized to direct light upwards. The diffuser 704 can make the light isotropic with uniform angular distribution. The diffuser can be tuned to control the angle of light into the QD sheet. Some of the light can excite the QDs and some of the light can pass through the QD sheet. Both the light that emitted from excited QDs and light from the LEDs that passed through the QD sheet can then pass through a bottom prism sheet 705 and top prism sheet 706. The purpose of the sheets can be to adjust the angle of light output towards the liquid crystal module 708 for enhanced display performance. In some examples, an additional diffuser sheet can be placed between the top prism sheet and the liquid crystal module for further light mixing, to compensate for any non-uniformities, or to account for hotspots. In some examples, any of the diffuser sheets can be a gradient diffuser sheet that can be used to compensate for loss of light intensity along the length of the light guide path. In some examples, the diffuser sheet between the light guide path and the QD sheet can be a high density diffuser sheet to ensure uniform intensity of light impinging on the QD sheet. In some examples, the bottom prism sheet and the top prism sheet can be replaced by diffuser sheets.

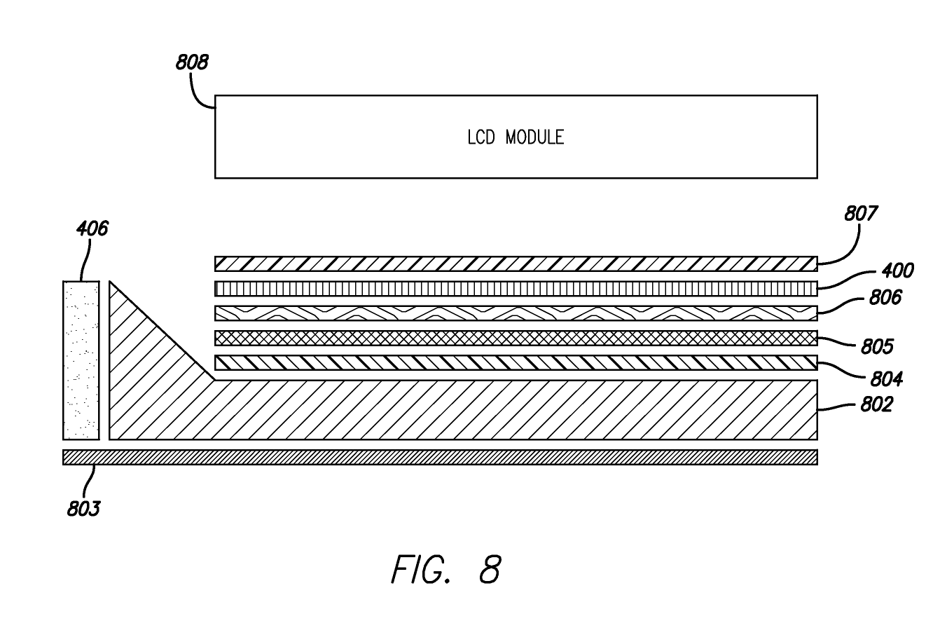

FIG. 8 illustrates an exemplary stackup of layers in a display system utilizing QDs with QD sheet 400 located between the top prism sheet 806 and diffuser sheet 807. Edge emitting LEDs can acts as the light source 406, which can be directed into the light guide path 802. The light guide path can spatially distribute the light along the area of the display and can be optimized to direct light upwards. For light directed downwards, the reflector 803 can redirect it and block it from exiting the display from the bottom. The diffuser 804 can allow for better angular distribution in all directions and improved light mixing. After the diffuser, the light can pass through the bottom prism sheet 805 and top prism sheet 806. This can allow for the angle of light output to be adjusted and directed closer towards the liquid crystal module 808 or the top of the display. Following this is the QD sheet. Some of the light can excite the QDs and some of the light can pass through the QD sheet. On top of the QD sheet can be an additional diffuser sheet 807 for mixing of light from excited QDs and light that passed through the QD sheet. The light exiting the two prism sheets may be tightly collimated and therefore an additional diffuser sheet on top can be used to prevent light into the liquid crystal module from also being collimated. In some examples, any of the diffuser sheets can be a gradient diffuser sheet that can be used to compensate for loss of light intensity along the length of the light guide path. In some examples, the diffuser sheet between the light guide path and the QD sheet can be a high density diffuser sheet to ensure uniform intensity of light impinging on the QD sheet. In some examples, the bottom prism sheet and top prism sheet can be replaced by diffuser sheets.

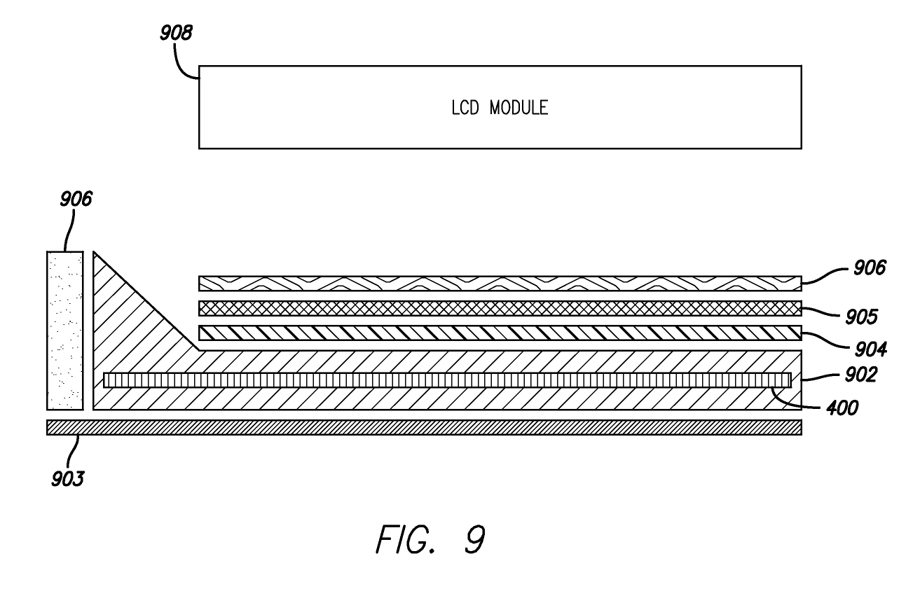

FIG. 9 illustrates an exemplary stackup of layers in a display system utilizing QDs with QD sheet 400 embedded into the light guide path 902. Edge emitting LEDs can act as the light source 406 and can direct light into the light guide path 902. The light guide path can then spatially distribute and direct the light out of the light guide path. The light guide path can be optimized to direct light both upwards and downwards by adjusting the types of shapes, size of the shapes, and density of the shapes. The reflector 903 can block light from exiting the display from the bottom and redirect the light upwards. On top of the light guide path can be a diffuser 904 which can make the light isotropic with uniform angular distribution. On top of the diffuser sheet can be a bottom prism sheet 905 and a top prism sheet 906. The purpose of the sheets can be to adjust the angle of light output towards the liquid crystal module 908 for enhanced display performance. In some examples, an additional diffuser sheet can be placed between the top prism sheet and the liquid crystal module for further light mixing, to compensate for any non-uniformities, or to account for hotspots. In some examples, the bottom prism sheet and the top prism sheet can be replaced by diffuser sheets. In some examples, any of the diffuser sheets can be a gradient diffuser sheet that can be used to compensate for loss of light intensity along the length of the light guide path. This exemplary stackup may lead to a thinner profile of the display due to the embedded QD sheet creating a fewer number of overall layers.

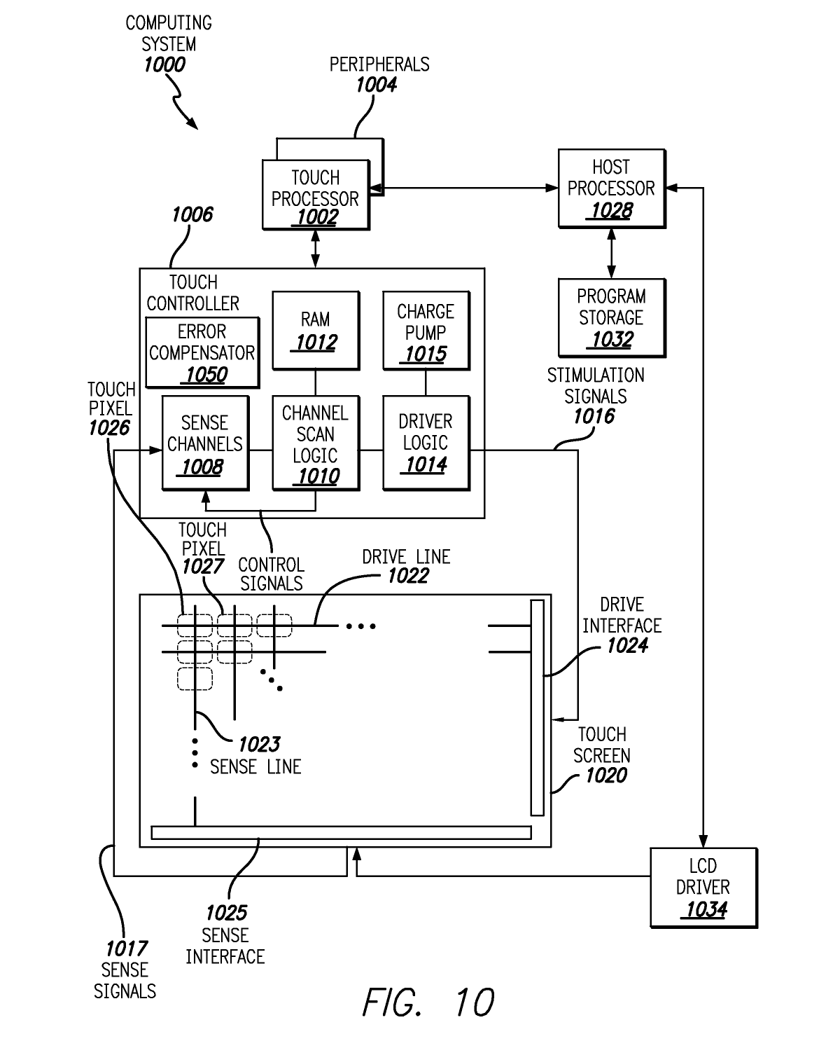

FIG. 10 is a block diagram of an example computing system 1000 that illustrates one implementation of an example display utilizing QDs with a touch screen 1020 according to examples of the disclosure. Computing system 1000 could be included in, for example, mobile telephone 136, digital media player 140, personal computer 144, or any mobile or non-mobile computing device that includes a touch screen. Computing system 1000 can include a touch sensing system including one or more touch processors 1002, peripherals 1004, a touch controller 1006, and touch sensing circuitry. Peripherals 1004 can include, but are not limited to, random access memory (RAM) or other types of memory or storage, watchdog timers and the like. Touch controller 1006 can include, but is not limited to, one or more sense channels 1008, channel scan logic 1010 and driver logic 1014. Channel scan logic 1010 can access RAM 1012, autonomously read data from the sense channels and provide control for the sense channels. In addition, channel scan logic 1010 can control driver logic 1014 to generate stimulation signals 1016 at various frequencies and phases that can be selectively applied to drive regions of the touch sensing circuitry of touch screen 1020, as described in more detail below. In some examples, touch controller 1006, touch processor 1002 and peripherals 1004 can be integrated into a single application specific integrated circuit (ASIC).

Computing system 1000 can also include a host processor 1028 for receiving outputs from touch processor 1002 and performing actions based on the outputs. For example, host processor 1028 can be connected to program storage 1032 and a display controller, such as an LCD driver 1034. Host processor 1028 can use LCD driver 1034 to generate an image on touch screen 1020, such as an image of a user interface (UI), and can use touch processor 1002 and touch controller 1006 to detect a touch on or near touch screen 1020, such a touch input to the displayed UI. The touch input can be used by computer programs stored in program storage 1732 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1028 can also perform additional functions that may not be related to touch processing.

Integrated display and touch screen 1020 can include touch sensing circuitry that can include a capacitive sensing medium having a plurality of drive lines 1022 and a plurality of sense lines 1023. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 1022 can be driven by stimulation signals 1016 from driver logic 1014 through a drive interface 1024, and resulting sense signals 1017 generated in sense lines 1023 can be transmitted through a sense interface 1025 to sense channels 1008 (also referred to as an event detection and demodulation circuit) in touch controller 1006. In this way, drive lines and sense lines can be part of the touch sensing circuitry that can interact to form capacitive sensing nodes, which can be thought of as touch picture elements (touch pixels), such as touch pixels 1026 and 1027. This way of understanding can be particularly useful when touch screen 1020 is viewed as capturing an “image” of touch. In other words, after touch controller 1006 has determined whether a touch has been detected at each touch pixel in the touch screen, the pattern of touch pixels in the touch screen at which a touch occurred can be thought of as an “image” of touch (e.g. a pattern of fingers touching the touch screen).

In some examples, touch screen 1020 can be an integrated touch screen in which touch sensing circuit elements of the touch sensing system can be integrated into the display pixels stackups of a display.

Therefore, according to the above, some examples of the disclosure are directed to a display comprising a light source, a backlight sub-stackup including a plurality of layers, wherein at least one of the plurality of layers includes a quantum dot sheet, and a liquid crystal module. Additionally or alternatively to one or more of the examples disclosed above, in some examples, the plurality of layers further includes at least one of a light guide path, a reflector, a prism sheet, and a diffuser sheet. Additionally or alternatively to one or more of the examples disclosed above, in some examples, the size and density of quantum dots formed on the quantum dot sheet and thickness of the quantum dot sheet are configured in accordance with a predetermined angle of incoming light. Additionally or alternatively to one or more of the examples disclosed above, in some examples, the quantum dot sheet is disposed between the reflector and the light guide path. Additionally or alternatively to one or more of the examples disclosed above, in some examples, the light guide path is configured to direct light downwards towards the quantum dot sheet. Additionally or alternatively to one or more of the examples disclosed above, in some examples, the quantum dot sheet is disposed between the light guide path and the diffuser sheet. Additionally or alternatively to one or more of the examples disclosed above, in some examples, the quantum dot sheet is disposed between the diffuser sheet and the prism sheet. Additionally or alternatively to one or more of the examples disclosed above, in some examples, the quantum dot sheet is embedded in the light guide path. Additionally or alternatively to one or more of the examples disclosed above, in some examples, the light guide path is configured to direct light both downwards towards the reflector and upwards towards the liquid crystal module. Additionally or alternatively to one or more of the examples disclosed above, in some examples, the quantum dot sheet is disposed between the prism sheet and the liquid crystal module.

Some examples of the disclosure are directed to a method of forming a display comprising locating a quantum dot sheet between a light source and liquid crystal material and within a backlight sub-stackup of the display, and producing white light for the liquid crystal material by directing light from the light source through the quantum dot sheet. Additionally or alternatively to one or more of the examples disclosed above, in some examples, the method further comprises forming the backlight sub-stackup from at least one of a light guide path, a reflector, a prism sheet, and a diffuser sheet. Additionally or alternatively to one or more of the examples disclosed above, in some examples, the method further comprises configuring a size and density of quantum dots in the quantum dot sheet and a thickness of the quantum dot sheet in accordance with a predetermined angle of incoming light. Additionally or alternatively to one or more of the examples disclosed above, in some examples, the method further comprises locating the quantum dot sheet between the reflector and the light guide path. Additionally or alternatively to one or more of the examples disclosed above, in some examples, the method further comprises configuring the light guide path to direct light downwards towards the quantum dot sheet. Additionally or alternatively to one or more of the examples disclosed above, in some examples, the method further comprises locating the quantum dot sheet between the light guide path and the diffuser sheet. Additionally or alternatively to one or more of the examples disclosed above, in some examples, the method further comprises locating the quantum dot sheet between the diffuser sheet and the prism sheet. Additionally or alternatively to one or more of the examples disclosed above, in some examples, the method further comprises locating the quantum dot sheet in the light guide path. Additionally or alternatively to one or more of the examples disclosed above, in some examples, the method further comprises configuring the light guide path to direct light both downwards towards the reflector and upwards towards the liquid crystal module. Additionally or alternatively to one or more of the examples disclosed above, in some examples, the method further comprises locating the quantum dot sheet between the prism sheet and the liquid crystal module.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A display, comprising:
a light source;
a backlight sub-stackup including a plurality of layers, wherein at least one of the plurality of layers includes a quantum dot sheet; and
a liquid crystal module.

2. The display of claim 1, wherein the plurality of layers further includes at least one of a light guide path, a reflector, a prism sheet, and a diffuser sheet.

3. The display of claim 1, wherein the size and density of quantum dots formed on the quantum dot sheet and thickness of the quantum dot sheet are configured in accordance with a predetermined angle and intensity of incoming light.

4. The display of claim 2, wherein the quantum dot sheet is disposed between the reflector and the light guide path.

5. The display of claim 2, wherein the light guide path is configured to direct light downwards towards the quantum dot sheet.

6. The display of claim 2, wherein the quantum dot sheet is disposed between the light guide path and the diffuser sheet.

7. The display of claim 2, wherein the quantum dot sheet is disposed between the diffuser sheet and the prism sheet.

8. The display of claim 2, wherein the quantum dot sheet is embedded in the light guide path.

9. The display of claim 8, wherein the light guide path is configured to direct light both downwards towards the reflector and upwards towards the liquid crystal module.

10. The display of claim 2, wherein the quantum dot sheet is disposed between the prism sheet and the liquid crystal module.

11. A method of forming a display, comprising:
locating a quantum dot sheet between a light source and liquid crystal material and within a backlight sub-stackup of the display; and
producing white light for the liquid crystal material by directing light from the light source through the quantum dot sheet.

12. The method of claim 11, further comprising forming the backlight sub-stackup from at least one of a light guide path, a reflector, a prism sheet, and a diffuser sheet.

13. The method of claim 11, further comprising configuring a size and density of quantum dots in the quantum dot sheet and a thickness of the quantum dot sheet in accordance with a predetermined angle and intensity of incoming light.

14. The method of claim 12, further comprising locating the quantum dot sheet between the reflector and the light guide path.

15. The method of claim 14, further comprising configuring the light guide path to direct light downwards towards the quantum dot sheet.

16. The method of claim 12, further comprising locating the quantum dot sheet between the light guide path and the diffuser sheet.

17. The method of claim 12, further comprising locating the quantum dot sheet between the diffuser sheet and the prism sheet.

18. The method of claim 12, further comprising locating the quantum dot sheet in the light guide path.

19. The method of claim 18, further comprising configuring the light guide path to direct light both downwards towards the reflector and upwards towards the liquid crystal module.

20. The method of claim 12, further comprising locating the quantum dot sheet between the prism sheet and the liquid crystal module.
